(19) United States
(12) Patent Application Publication
(10) Pub. No.: US 2025/0265805 A1
(43) Pub. Date: Aug. 21, 2025

(54) Apparatus, Method and Computer Program

(71) Applicant: Leica Microsystems CMS GmbH, Wetzlar (DE)

(72) Inventors: Hideki SASAKI, Wetzlar (DE); Chi-Chou HUANG, Wetzlar (DE)

(21) Appl. No.: 19/044,732

(22) Filed: Feb. 4, 2025

(30) Foreign Application Priority Data
Feb. 19, 2024 (DE) 10 2024 104 533.7

(51) Int. Cl. G06V 10/34; G06V 10/28; G06V 20/69

(52) U.S. Cl. CPC G06V 10/34; G06V 10/28; G06V 20/695

(57) ABSTRACT

Examples relate to an apparatus comprising one or more processors and one or more storage devices. The apparatus is configured to obtain reference sample data indicative of a first image of a sample from a first channel and to obtain threshold data indicative of a plurality of thresholds for performing a distance transformation. Further, the apparatus is configured to generate, using at least two thresholds of the plurality of thresholds, reference data by applying the distance transformation to the reference sample data. The apparatus is further configured to obtain sample data indicative of a second image of the sample from a second channel different from the first channel and to generate structure image data indicative of a structure of the sample. The structure image data is generated based on the reference data and the sample data.

### TECHNICAL FIELD

Examples relate to an apparatus, a method and a computer program.

### BACKGROUND

In certain spatial analysis contexts, it becomes essential to modulate the expression signals of biomarkers by either enhancing or suppressing them based on the proximity or distance between objects labeled with different biomarkers. For instance, examining the spatial relationships between individual cells, as indicated by biomarker expressions in multiplexed images, can provide valuable insights into potential cell interactions, associations, and spatial arrangements. While segmentation techniques are commonly employed for this purpose, they may encounter challenges, particularly in multiplexed biomarker image sets characterized by intricate structures, noisy backgrounds, or quality issues. Thus, there may be a desire for an improved concept for analyzing a multiplexed biomarker image set.

### SUMMARY

This desire is addressed by the subject-matter of the independent claims.

The concept proposed in the present disclosure is based on the insight, that structure image data indicative of a structure of the sample can be generated using reference data and sample data. The reference data can be generated by applying the distance transformation using multiple thresholds. Based on the distance transformation a distance transformed reference image can be provided to enhance or suppress pixel values of a target image of a sample. In this way, a segmentation-free process may be provided to enhance or suppress pixel values in a target image of a sample. In this way, a visibility of a structure of the sample can be improved.

Examples provide an apparatus comprising one or more processors and one or more storage devices. The apparatus is configured to obtain reference sample data indicative of a first image of a sample from a first channel and to obtain threshold data indicative of a plurality of thresholds for performing a distance transformation. Further, the apparatus is configured to generate, using at least two thresholds of the plurality of thresholds, reference data by applying the distance transformation to the reference sample data. The apparatus is further configured to obtain sample data indicative of a second image of the sample from a second channel different from the first channel and to generate structure image data indicative of a structure of the sample. The structure image data is generated based on the reference data and the sample data. Applying the distance transformation using at least two thresholds may allow to improve the accuracy and robustness of the distance transformation. Thus, the distance transformation can be used in conjunction with the sample data for generating the structure image data even for complex structures. Further, the at least two thresholds may increase evaluability of the reference sample data and thus may improve the reference data. In this way, a susceptibility to errors when generating the structure image data can be reduced.

In an example, generating the reference data may comprise applying a mapping function to a distance transformed first image of the sample. The mapping function may allow to enhance or suppress pixel values in the second image based on the distance transformed first image. For example, different functions such as monotonically decreasing functions or monotonically increasing functions can be used as mapping function. In this way, pixel values in the second image can be adjusted in a desired way.

In an example, the mapping function may be a monotonically decreasing function, a monotonically increasing function and/or a band pass function. Thus, the presentation or visibility of the structure of the sample can be adjusted in a desired way.

In an example, the distance transformation may be a grayscale distance transformation. A grayscale distance transformation may allow a simpler and more efficient computation than a standard distance transformation that requires a binary segmentation mask as the input.

Thus, the structure image data can be generated in a facilitated way.

In an example, the apparatus may be further configured to generate superposition image data indicative of the structure of the image. The superposition image data is generated based on the structure image data and the reference data. The superposition image data may allow to improve a presentation or visibility of the structure of the sample.

In an example, a threshold of the plurality of thresholds for performing the distance transformation may be an intensity threshold for retaining or for excluding pixels for performing the distance transformation. That is, the threshold value can define the pixel value above which a pixel in the first image can be regarded as background or foreground.

In an example, the apparatus may be configured to generate intermediate binary data indicative of a plurality of binary-like representations or a plurality of binary masks for performing the distance transformation. The intermediate binary data is generated based on the reference sample data and the threshold data. Further, generating the reference data may comprise applying the distance transformation to the binary data for generating a plurality of distance transformed first images. Using a plurality of binary-like representations or a plurality of binary masks can allow the generation of average distance transformed data (indicative of an average distance transformed first image) by generating a plurality of intermediate distance transformed first images. The averaged distance transformed data may improve the efficiency, accuracy, robustness and/or interpretability of spatial analysis tasks. In this way, the structure image data can be improved.

In an example, the first channel and the second channel may be part of one multiplexed image set. That is, the reference sample data and the sample data may be obtained simultaneously. Therefore, the apparatus can generate the structure image data based on a multiplexed image set of a sample.

In an example, generate the structure image data may be a segmentation-free process. Thus, the generation of the structure image data can be facilitated and/or improved.

In an example, generating the structure image data may retain an unsegmented characteristic of the first image of the sample and the second image of the sample. That is, the structure image data can be generated without segmentation. Thus, error prone segmentation can be avoided.

In an example, generating the structure image data may comprise emphasizing a part of the second image corresponding to a part of the reference data with a short distance and/or attenuating a part of the second image corresponding to a part of reference data with a long distance. Thus, a distance transformation can be used for generating structure image data. Using the distance transformation may allow to avoid segmentation of the first image and/or the second image.

In an example, generating the structure image data may comprise emphasizing a spatial feature in the sample image data that correspond to a structure represented by distance values in the reference data. For example, the spatial feature, e.g., a structure, can be emphasized based on the representation of the structure in the first image. That is, no segmentation may be required to emphasize the spatial feature in the second image.

In an example, the reference sample data may be raw reference sample data of the first image of the sample and the distance transformation for generating the reference data is applied to the raw reference sample data. That is, the distance transformation may be applied directly to the reference sample data without any further pre-processing. In this way, generating the reference data can be facilitated.

In an example, the sample data may be raw sample data of the second image, and generating the structure image data may comprise superposition of the reference data with the raw sample data. That is, the sample data may be directly superimposed with reference data without any further pre-processing, e.g., without segmentation. In this way, generating the structure image data can be facilitated.

In an example, the first image of the sample is indicative of a first biomarker and the second image of the sample is indicative of a second biomarker.

Examples provide a method comprising obtaining reference sample data indicative of a first image of a sample from a first channel and obtaining threshold data indicative of a plurality of thresholds for performing a distance transformation. Further, the method comprises generating, using at least two thresholds of the plurality of thresholds, reference data by applying the distance transformation to the reference sample data and obtaining sample data indicative of a second image of the sample from a second channel different from the first channel. The method further comprises generating, based on the reference data and the sample data, structure image data indicative of a structure of the sample.

Various examples of the present disclosure relate to a corresponding computer program with a program code for performing the above method when the computer program is executed on a processor.

### SHORT DESCRIPTION OF THE FIGURES

Some examples of apparatuses and/or methods will be described in the following by way of example only, and with reference to the accompanying figures, in which

FIG. 1 shows a schematic diagram of an example of an apparatus;

FIG. 2 shows a flow diagram of an example of a method for generating structure image data;

FIG. 3 shows an example of a flow diagram of grayscale distance transformation;

FIGS. 4a-4i show examples of mapping functions;

FIG. 5 shows a flow diagram of a method; and

FIG. 6 shows a schematic diagram of a system comprising a microscope and a computer system.

### DETAILED DESCRIPTION

Various examples will now be described more fully with reference to the accompanying drawings in which some examples are illustrated. In the figures, the thicknesses of lines, layers and/or regions may be exaggerated for clarity.

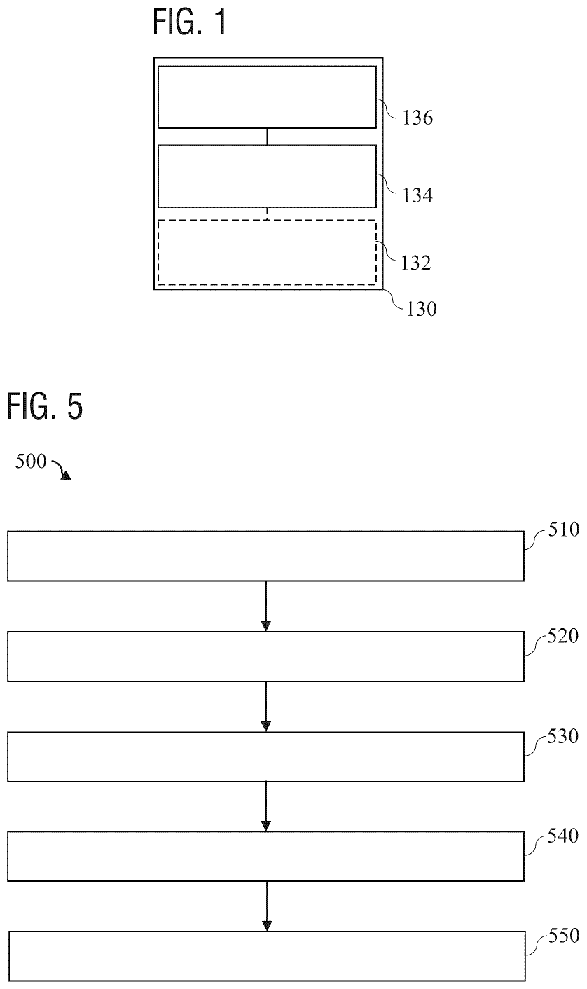

FIG. 1 shows a schematic diagram of an example of an apparatus 130. The apparatus 130 comprises, as shown in FIG. 1, one or more processors 134 and one or more storage devices 136. Optionally, the apparatus 130 further comprises one or more interfaces 132. The one or more processors 134 are coupled to the one or more storage devices 136 and to the optional one or more interfaces 132. In general, the functionality of the apparatus 130 may be provided by the one or more processors 134 (e.g., for generating the structure image data), in conjunction with the one or more interfaces 132 (for exchanging information, e.g., obtaining the reference sample data) and/or with the one or more storage devices 136 (for storing and/or retrieving information).

The apparatus 130 is configured to obtain reference sample data indicative of a first image of a sample from a first channel. The reference sample data can be obtained by receiving or retrieving from an optical imaging system and/or an external storage device. For example, the sample data may be obtained by receiving the sample data from an optical imaging system (e.g., via the interface 132), by retrieving the sample data from a memory of an optical imaging system (e.g., via the interface 132) or another external storage device and/or by retrieving the sample data from a storage device 136 of the apparatus 130, e.g., after the sample data has been written to the storage device 136 by an optical imaging system or by another system or processor, e.g., comprising an external storage device.

Image data or a dataset acquired through image acquisition of a sample may contain information specific to a particular tissue type or molecular marker, obtained through imaging techniques such as immunofluorescence or immunohistochemistry. For example, the sample may be a sample from which image data was acquired using imaging techniques such as an optical imaging system. The image data may be a multidimensional dataset. That is, the acquired image data of the sample may comprise individual images or datasets representing different biological samples, e.g., proteins, and/or molecular targets, e.g., biomarkers. For example, the first image of the sample from the first channel may be part of image data acquired through image acquisition of a sample. The acquired image data can be multiplexed to extract a channel or layer of information into a single image, e.g., the first image. That is, the first image of the sample from the first channel may be generated by multiplexing the image data. Multiplexing can involve the extraction of a single channel or spectral component from a multidimensional datasets, e.g., the image data, enabling focused analysis and interpretation of specific features within the data. For example, the first image may represent a specific biomarker part of the sample, for example. Multiplexing may enable simultaneous visualization and analysis of multiple targets within the same sample, facilitating comprehensive characterization and understanding of complex biological systems. For example, in hyperspectral imaging, where each pixel contains information across a range of wavelengths, multiplexing techniques may be employed to extract and analyze the spectral signature of particular materials or substances within the sample, e.g., different biomarkers.

As described above, the apparatus 130 may obtain the reference sample data by receiving or retrieving. Alternatively, the apparatus 130 may receive or retrieve image data and may determine the reference sample data based on the image data, e.g., by multiplexing. For example, the apparatus 130 may receive the image data as raw data of an optical imaging sensor of an optical imaging system. For example, multiplexing the image data may be performed by the apparatus 130 by dividing the raw data of an optical imaging sensor into multiple channels leading to a multiplexed image set. Thus, the apparatus 130 may generate a multiplexed image set (based on the image data) or may receive or retrieve a multiplexed image set. When the multiplexed image set is received or retrieved, an external processor, e.g., a control unit of an optical imaging system, has generated the multiplexed image set.

A multiplexed image set enables the isolation and analysis of individual spectral channels, allowing researchers to study specific features or characteristics within the image data. For instance, when dealing with multiple biomarkers exhibiting overlapping spectra, individual spectral channels can be extracted from a comprehensive dataset, e.g., the image data. This approach facilitates focused analysis of each spectral signature of a biomarker, even in cases where their spectra overlap, thereby enabling a detailed examination of each presence of biomarkers and distribution of biomarkers within the sample.

In general, a biomarker may not only accumulate in (i.e., label) one structure (or spatial feature) but in multiple structures, such as blood vessels, mesenchymal cells, fibroblasts, or endothelial cells. Thus, a channel may provide no distinct information about a specific structure. Nevertheless the channel can be used to extract desired information about a specific structure, e.g., using reference data from a reference channel comprising a biomarker which accumulates in only one structure. Each channel may provide unique information about the properties of the sample (which was captured). Analyzing these channels collectively may allow for a more comprehensive understanding of the sample under study. That is, two different biomarkers of two different channels can be used for generating a spatial context feature image, e.g., to enhance a visibility of a structure.

For example, the first channel may be one distinct channel of a multiplexed image set. The first image of the sample may be an image in which a biomarker accumulated in only one structure of the sample. That is, the first image of the sample can be used as reference for another channel comprising a different image of the sample, e.g., a second image of the sample comprising a biomarker accumulated in multiple structures. Thus, the first image of the sample can be utilized to enhance a specific structure of the multiple structures in the second image of the sample for generating a spatial context feature image. For example, a first biomarker may be accumulated in a first structure of the first image. A second biomarker may be accumulated in multiple structures of the second image of the sample including the first structure. In this case, the first image of the sample can be used to enhance the first structure (or suppress the other structures) in the second image. Thus, the first image of the sample can be used for generating a special context feature image in which the first structure is enhanced. For generating the spatial context feature image of distance transformation may be used.

To quantify the distance between objects labeled by two biomarkers of two different channels, it is known to segment both target and reference objects from their respective biomarker images or channels. Subsequently, a standard distance transformation can be applied to a segmentation mask obtained from the segmentation of the reference marker image. For example, a spatial feature is determined based on a standard distance transformation that requires a segmentation mask as the input. Based on the segmentation mask target objects are retained if they fall within the specified distance threshold, while those lying outside the designated range are removed. However, the segmentation process is time resource consuming and also error prone. No single segmentation method can consistently execute the segmentation process for a multiplexed biomarker image set, particularly for images with complex structures, noisy backgrounds, or quality issue. It is a finding of the inventors, that a generation of a spatial contextual feature image can be improved by segmentation-free process. That is, the apparatus 130 is configured to perform an operation which may be segmentation free. Thus, no segmentation mask may be needed. The operation is based on the reference sample data (as described above), a distance transformation and sample data from an interesting channel. The apparatus 130 can avoid segmentation and can directly quantifies the proximity or distance between individual structures in multiplexed biomarker images.

To enhance or suppress data biomarker expression signals labeled by different biomarkers, i.e., from different channels, a distance transformation can be utilized. Thus, the apparatus 130 may be configured to perform a distance transformation. Therefore, the apparatus 130 is configured to obtain threshold data indicative of a plurality of thresholds for performing a distance transformation. A threshold is a predefined value used to divide a grayscale or color image, e.g., the first image, into two regions based on pixel intensity. Pixels with intensities above the threshold are typically classified as foreground (or structure), while pixels below the threshold are classified as background.

The threshold data can be obtained by receiving or retrieving from an optical imaging system and/or an external storage device. For example, the threshold data may be obtained by receiving the threshold data from an optical imaging system (e.g., via the interface 132), by retrieving the threshold data from a memory of an optical imaging system (e.g., via the interface 132) or another external storage device and/or by retrieving the threshold data from a storage device 136 of the apparatus 130, e.g., after the threshold data has been written to the storage device 136 by an optical imaging system or by another system or processor, e.g., comprising an external storage device.

Further, the apparatus 130 is configured to generate reference data by applying the distance transformation to the reference sample data. The reference data is generated using at least two thresholds of the plurality of thresholds. The reference data may be indicative of a distance transformed first image of the sample. For example, the distance transformed first image of the sample may be generated by averaging multiple intermediate distance transformed first images of the sample as described below. That is, the apparatus 130 can use the threshold data to perform a distance transformation. The distance transformation multiple intermediate distance transformation for generating multiple intermediate distance transformed first images. Further, the distance transformation may comprise averaging over multiple intermediate distance transformation, i.e., averaging the multiple intermediate distance transformed images. Each intermediate distance transformation may be based on a threshold of the plurality of thresholds. For example, the threshold data can be used for generating binary data (as described in more detail below) or to identify regions of interest within the first image. The distance transformation can be performed based on the binary data or the region of interest within the first image. The distance transformed first image may comprise information about a transformed first image that typically may include the distances from each pixel to a specific structure (or spatial feature) or region of interest in the first image.

The distance transformation can be directly applied to the reference sample data for generating the distance transformed first image. This circumvents the need for segmenting the first image. That is, the reference sample data can be used as reference to provide a spatial context feature image without segmentation. Therefore, based on the reference sample data a structure within another image of the sample can be enhanced or suppressed.

Thus, the apparatus 130 is further configured to obtain sample data indicative of a second image of the sample from a second channel different from the first channel. In principle, the sample data can be obtained in the same way as the reference sample data. For example, the second channel may be one distinct channel of a multiplexed image. For example, the second image of the sample from the second channel may be part of image data acquired through image acquisition of a sample. The acquired image data may be multiplexed for generating the second image (and optionally simultaneously the first image). That is, the second image of the sample from the second channel may be generated by multiplexing the image data. For example, the second image or the second channel may be part of the same multiplexed image set as the first image of the first channel. The multiplexed image set may be generated based on image data acquired through image acquisition of a sample. That is, the sample data may be obtained simultaneously with the reference sample data, e.g., by receiving a multiplexed image set comprising the first channel and the second channel. Alternatively, the sample data may be obtained separately from the reference sample data. For example, the apparatus 130 may determine the sample data separate from the reference sample data based on image data.

A structure within the second image of the sample can be enhanced by using the reference sample data. This may allow for generating an image of the sample in which a visibility of a desired structure is improved. Thus, the apparatus 130 is configured to generate structure image data indicative of a structure of the sample. The structure image data is generated based on the reference data and sample data. For example, the reference data and sample data can be multiplicated for generating structure image data. The structure image data may comprise information about a spatial contextual feature image showing the structure of the sample. The generation of the structure image data may enhance target signals (i.e., pixel values in a target image, namely the second image) when they are close to reference signals of the first image (i.e., pixel values in the distance transformed first image, e.g., corresponding to the first structure), while simultaneously suppress them if they are far away from the reference signals. In this way, a structure within the second image can be enhanced based on a structure, e.g., the same structure or a comparable structure, within the first image. In this way, a visibility of a structure of the sample can be improved.

In principle, a pixel value in the second image is also referred to as target signal, as the second image is the target for determining or improving a structure. A pixel value in the distance transformed first image (or the mapped distance transformed first image, as described below) is also referred to as reference signal, as the first image can be used as reference for enhancing or suppressing the target signal. The pixel values in the first image may result from a first biomarker. The pixel values in the second image may result from a second biomarker different from the first biomarker. That is, the target signal may be indicative of at least one spatial feature (e.g., a structure) the second biomarker accumulated in. The reference signal may be indicative of at least one spatial feature the first biomarker accumulated in. Thus, reference (biomarker) signals can be used to enhance or suppress target (biomarker) signals. A target signal or reference signal can result from a specific biomarker in the sample.

In principle every digital image could be used as first image or second image. For example, the first image and/or the second image may be a fluorescence image and/or a confocal image acquired by image acquisition of a sample and multiplexing of the acquired image data.

Thus, the apparatus 130 may be configured to generate a spatial contextual feature image based on a reference image (e.g., the first image) comprising information about a first biomarker (also referred to as reference marker) and a target image (e.g., the second image) comprising information about a second biomarker (also referred to as target market) different from the first biomarker. That is, the apparatus 130 may employ a segmentation-free process for generating a spatial contextual feature image.

A spatial contextual feature image may be an image that represents a spatial relationship within a given sample or a dataset acquired by image acquisition of a sample. Rather than directly depicting the physical appearance of objects, it encodes information about the spatial layout, arrangement, or relationships between different elements within the sample. Therefore, the structure of the sample may be integrated into or form part of the spatial contextual feature image. That is, the process of applying a distance transformation and generating the structure image data based on the reference data and the sample data may be a segmentation-free operation.

The structure image data generated by the apparatus 130 may be considered to not be based on a segmentation technique. Segmentation typically involves partitioning an image into distinct regions or components based on certain criteria, such as intensity, color, or texture similarity. While distance transformation may utilize a binary mask, for example, it does not partition the image into separate regions, but rather calculates the distance of each pixel to a nearest boundary or edge. That is, distance transformation is quantifying the spatial relationships within the image rather than segmenting it into distinct regions. This distinguishes distance transformation from traditional segmentation techniques, in which an image is partitioned based on certain criteria to delineate objects.

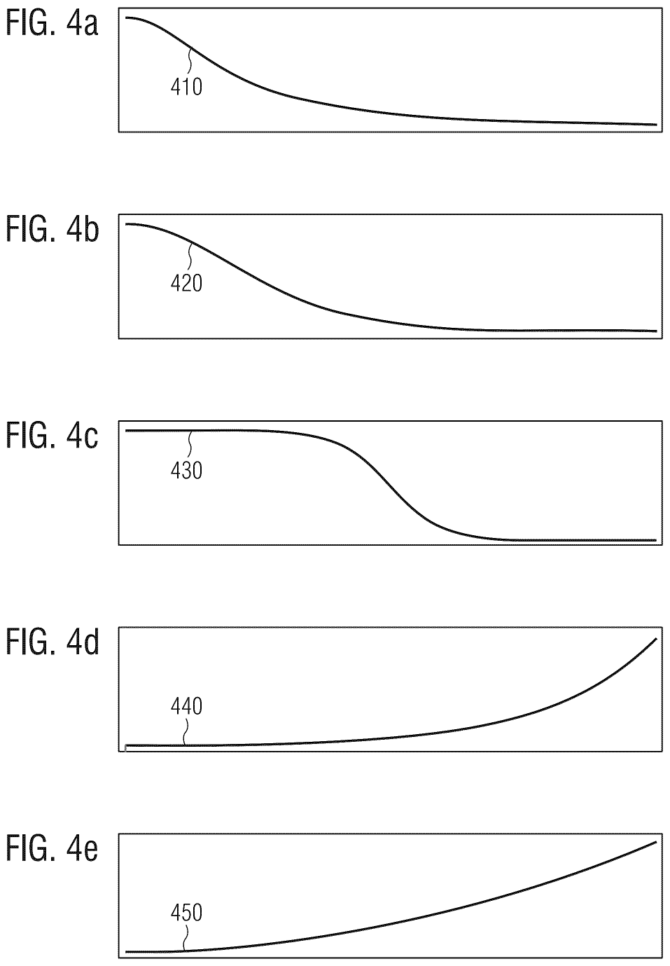

In an example, generating the reference data may comprise applying a mapping function to a distance transformed first image of the sample. The mapping function may be applied to individual pixels of the distance transformed first image. For example, the mapping function may be applied to a plurality of pixels, e.g., subsequently all pixels or each pixel, of the distance transformed first image to convert short distance values into high values and long-distance values into low values. For example, the mapping function can be applied to the distance transformed first image for generating a mapped distance transformed first image. The mapping function can provide control how target signals, i.e., pixel values in the second image, can be enhanced or suppressed based on the distance of the reference signal, i.e., pixel values in the mapped distance transformed first image (see also FIG. 4). For example, the mapping function may be a Gaussian function. Alternatively, the mapping function can be any desired function.

In an example, the mapping function is a monotonically decreasing function, a monotonically increasing function and/or a band pass function. For example, the mapping function may be a monotonically decreasing functions such as Cauchy distribution function, T-distribution function, flipped sigmoid function, to enhance target signals in proximity to the reference signals. For example, the mapping function may be a monotonically increasing functions such as exponential function, quadratic function, sigmoid function, Cauchy loss function, to enhance target signals distant from reference signals. For example, the mapping may be a band-pass functions such as band pass function, inverse band pass function, to enhance target signals that fall within a specific distance range relative to the reference signals.

In an example, the distance transformation may be a grayscale distance transformation. The grayscale distance transformation may be applied to the first image to produce a distance transformed first image in which pixels with lower intensity values indicate a closer proximity to reference signals (resulting from reference marker), for example.

In an example, a threshold of the plurality of thresholds for performing the distance transformation may be an intensity threshold for retaining or for excluding pixels for performing the distance transformation. Setting an intensity threshold may allow to selectively include or exclude pixels in the distance transformation process based on their intensity values. This may allow to focus the distance transformation on specific regions or features of interest within the first image. Selectively means to choose or pick certain elements or components from a larger set while disregarding others based on specific criteria or preferences. It involves making a deliberate choice to include or exclude certain items or actions in a targeted manner.

Further, the plurality of thresholds may allow to reduce noise. For example, intensity thresholds can help filter out noisy or irrelevant pixels from the distance transformation. By excluding low-intensity pixels that may correspond to noise or background clutter, the accuracy and reliability of the distance transformation and thus the structure image data can be improved.

Further, the plurality of thresholds may allow to improve a computational efficiency. Thresholding before performing distance transformation may reduce the number of pixels involved in the calculation, leading to improved computational efficiency. In this way, complex images can be analyzed in an improved way.

In an example, the apparatus 130 may be configured to generate intermediate binary data (or binary images) indicative of a plurality of binary-like representations or a plurality of binary masks for performing the distance transformation. The intermediate binary data is generated based on the reference sample data and the threshold data. Further, generating the reference data may comprise applying the distance transformation to the binary data for generating a plurality of intermediate distance transformed first images. That is, the output images, i.e., the binary data or binary images, of applying multiple thresholds can be subsequently used for applying the distance transform, i.e., a plurality of distance transformations. The plurality of distance transformation generated based on the plurality of binary-like representations or a plurality of binary masks can allow to provide an averaged distance transformation image. That is, the plurality of distance transformations may be used for generating a plurality of intermediate distance transformed first images. The plurality of intermediate distance transformed first images can be used for generating an average distance transformed first image. Thus, the distance transformation may be used for generation of the average distance transformed first image. That is, the distance transformed first image described above, can be also referred to as average distance transformed first image, because it is generated based on multiple thresholds.

In an example, the apparatus 130 may be configured to generate the (average) distance transformed first image by averaging the intermediate distance transformed first images. For example, each threshold of the plurality of threshold can be used for generating an intermediate distance transformed first image. Thus, the (average) distance transformed first image can be generated by averaging a plurality of intermediate distance transformed first images.

Binary data or a binary image refers to any image where each pixel can take on one of only two possible values, typically 0 and 1, representing background and foreground, respectively. The binary image can be a binary-like representation or a binary mask. A binary mask is a binary image where each pixel is classified as either foreground (structure) or background. A binary-like representation is a binary image that resembles or behaves like a binary mask, regardless of strict adherence to binary conventions.

The distance transformation may calculate the distance of each pixel in the binary image to the nearest boundary or edge, using a distance metric such as Euclidean distance. The output (data) of the distance transformation process is a distance transformed image. In this distance transformed image, the intensity value of each pixel represents its distance to the nearest boundary or edge in the original binary image. Pixels closer to the boundary have lower intensity values, while pixels further away have higher intensity values.

Distance transformation is to measure distances from each pixel to the nearest boundary in the binary image, rather than segmenting the image into distinct regions. Thus, the output data of distance transformation, i.e., the reference data, is a distance transformed first image where each value of pixels represents its distance to the nearest boundary in the binary image, rather than a segmented image with distinct regions. That is, no region partitioning is performed. While distance transformation provides valuable information about spatial relationships within the image, it does not partition the image into separate regions or components based on similarity criteria, as segmentation techniques do. Therefore, the apparatus 130 can avoid segmentation and directly quantifies the proximity or distance between individual objects in multiplexed biomarker images, e.g., the first image and the second image.

In an example, the apparatus 130 may be further configured to generate superposition image data indicative of the structure of the image. The superposition image data is generated based on the structure image data and the reference data. For example, the superposition image data may be generated by multiplying or dividing the distance transformed first image or the mapped distance transformed first image with or by the second image. In this way, the target signals of the second image are enhanced when in proximity to the reference signals and suppressed when distanced from the reference signals.

In an example, the first channel and the second channel may be part of one multiplexed image set. That is, the reference sample data and the sample data may be obtained simultaneously. For example, the apparatus 130 can generate the structure image data based on multiplexed images of a sample. For example, the apparatus 130 may just operate on two images selected from a multiplexed image set. For example, the apparatus 130 may retrieve a multiplexed image set and may select the first image and the second image from the retrieved multiplexed image set.

In an example, generate the structure image data may be a segmentation-free process. A segmentation-free process may provide spatial information without the need for explicit segmentation, simplifying the analysis process and reducing computational complexity. This approach can be particularly beneficial in scenarios where traditional segmentation methods may be challenging or impractical due to complex structures, noisy backgrounds and/or overlapping structures. By directly quantifying distances from each pixel to relevant features or boundaries, the apparatus 130 may allow for efficient analysis and interpretation of spatial relationships within the second image. In this way, a multiplexed images, e.g., the multiplexed image set, can be analyzed in an improved way.

In an example, generating the structure image data may retain an unsegmented characteristic of the first image of the sample and the second image of the sample. That is, the structure image data can be generated without segmentation. As described above this may allow for analysis of images with complex structures, noisy backgrounds and/or overlapping structures.

In an example, generating the structure image data may comprise emphasizing a part of the second image corresponding to a part of the reference data with a short distance and/or attenuating (or suppressing) a part of the second image corresponding to a part of reference data with a long distance. Thus, a distance transformation can be used for generating structure image data. Using the distance transformation may allow to avoid segmentation of the first image and/or the second image. For example, when examining the microenvironment surrounding T cells, it is advantageous to enhance target signals from target markers located near T cells (e.g., the second image) labeled with a T cell specific reference marker (e.g., the first image), while suppress target signals that distance from the T-cells. In this case, the first image would comprise reference signals indicating the spatial features of the T cells and could be used to enhance the target signals of the second signals corresponding to the T cells. The target signals could be indicative for the T cells and further structures. Using the reference signal may allow to emphasize the part of the second image corresponding to the labelled part of the first image resulting from the reference marker, i.e., the T cells. That is, the part of the second image indicating the T cells could be emphasized using the reference signal indicating only the T cells.

In an example, generating the structure image data may comprise emphasizing a spatial feature in the sample image data that corresponds to a structure represented by distance values in the reference data. For example, the spatial feature, e.g., a structure, can be emphasized based on the representation of the structure and the first image. For example, identifying blood vessels within multiplexed images may be performed using the apparatus 130. Blood vessels might be marked using various biomarkers. While some of these biomarkers (e.g., the reference marker) may exclusively label vessels, other biomarker (e.g., the target marker) could also label additional cell types, such as muscle cells. For example, the first image may result from a reference marker only accumulated in the blood vessel and the second image may result from a target marker accumulated in the blood vessels and other structures. In this case, the apparatus 130 can preprocess non-vessel-specific biomarker images, i.e., the second image, retaining only the signals that closely coincide with the signals from the vessel-specific markers, i.e., the first image. This preprocess can be performed by the apparatus 130 without segmentation.

In an example, the reference sample data may be raw reference sample data of the first image of the sample and the distance transformation for generating the reference data is applied to the raw reference sample data. That is, the distance transformation may be applied directly to the reference sample data without any further pre-processing. For example, the reference sample data may be retrieved from an external storage device. The raw reference sample data may be generated by multiplexing sensor data as described above. That is, raw reference data may be raw data generated by multiplexing sensor data, e.g., of an optical imaging sensor of an optical imaging system. In an example, the sample data may be raw sample data of the second image, and generating the structure image data may comprise superposition of the reference data with the raw sample data. That is, the sample data may be directly the superposed with reference data without any further pre-processing, e.g., without segmentation.

In an example, the first image of the sample is indicative of a first biomarker and the second image of the sample is indicative of a second biomarker.

The apparatus 130 may be external to an optical imaging system. Alternatively, the apparatus 130 may part of an optical imaging system, e.g., may be a control unit of the optical imaging system.

As shown in FIG. 1 the optional one or more interfaces 132 is coupled to the respective one or more processors 134 at the apparatus 130. In examples the one or more processors 134 may be implemented using one or more processing units, one or more processing devices, any means for processing, such as a processor, a computer or a programmable hardware component being operable with accordingly adapted software. Similar, the described functions of the one or more processors 134 may as well be implemented in software, which is then executed on one or more programmable hardware components. Such hardware components may comprise a general-purpose processor, a Digital Signal Processor (DSP), a micro-controller, etc. The one or more processors 134 is capable of controlling the one or more interfaces 132, so that any data transfer that occurs over the one or more interfaces 132 and/or any interaction in which the one or more interfaces 132 may be involved may be controlled by the one or more processors 134.

In an embodiment the apparatus 130 may comprise a memory, e.g., the one or more storage devices 136 and at least one or more processors 134 operably coupled to the memory and configured to perform the method described below.

In examples the one or more interfaces 132 may correspond to any means for obtaining, receiving, transmitting or providing analog or digital signals or information, e.g., any connector, contact, pin, register, input port, output port, conductor, lane, etc. which allows providing or obtaining a signal or information. The one or more interfaces 132 may be wireless or wireline and it may be configured to communicate, e.g., transmit or receive signals, information with further internal or external components.

The apparatus 130 may be a computer, processor, control unit, (field) programmable logic array ((F)PLA), (field) programmable gate array ((F)PGA), graphics processor unit (GPU), application-specific integrated circuit (ASICs), integrated circuits (IC) or system-on-a-chip (SoCs) system.

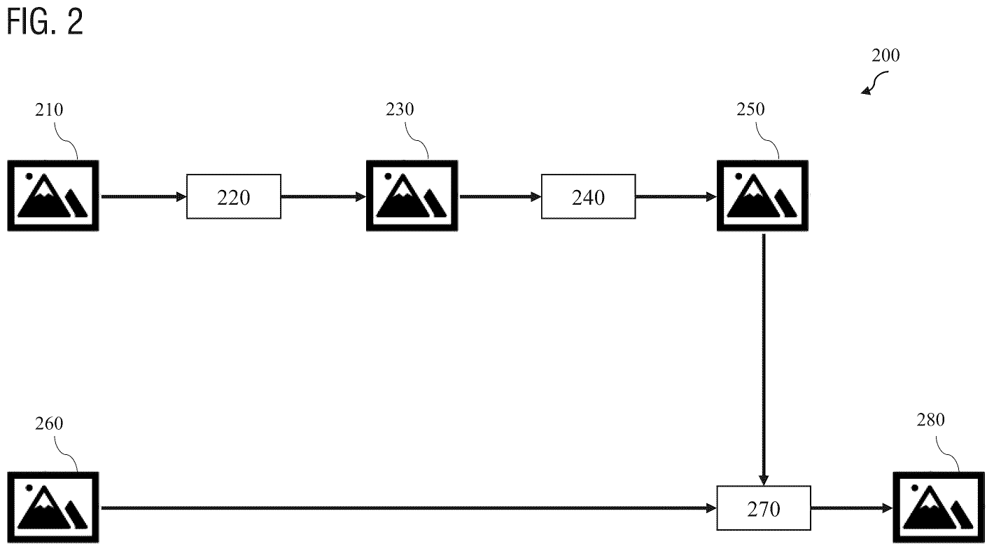

More details and aspects are mentioned in connection with the examples described below. The example shown in FIG. 1 may comprise one or more optional or additional features corresponding to one or more aspects mentioned in connection with the proposed concept or one or more examples described below (e.g., FIGS. 2-6).

FIG. 2 shows a flow diagram of an example of a method 200 for generating structure image data 280, e.g., a spatial contextual feature image 280. The method 200 may be performed by an apparatus as described above, e.g., with reference to FIG. 1.

The method 200 may comprise obtaining reference sample data, e.g., a reference marker image 210 (e.g., the first image). At 220 a distance transformation, e.g., a grayscale distance transformation, may initially be applied to the reference marker image 210, which may produce a distance transformed image 230. Pixels in the distance transformed image 230 with lower intensity values indicate closer proximity to the reference marker signals. The distance transformation may be performed as described above, e.g., using multiple thresholds and an optional binary mask.

At 240 a mapping function may be applied to individual pixels within the distance transformed image 230. Applying the mapping function may transform short distance values into high values and long-distance values into low values. The mapping function may be a Gaussian function with a zero mean, for example. The output data may be a mapped distance transformed image 250, e.g., a Gaussian-mapped image.

Further, the method may comprise obtaining sample data, e.g., a target marker image 260 (e.g., a second image). At 270 a superposition of the target marker image 260 and the mapped distance transformed image may be generated. The superposition produces a spatial contextual feature image 280. When a Gaussian function was used as mapping function, the target signals are enhanced when in proximity to the reference signals and suppressed when distanced from the reference signals. In this way, a spatial contextual feature image 280 can be generated without separation.

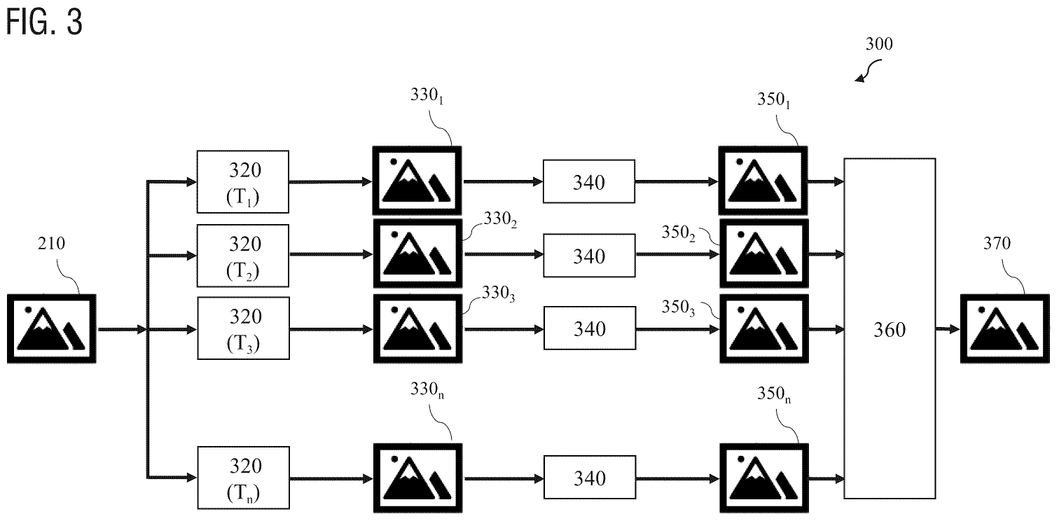

More details and aspects are mentioned in connection with the examples described above and/or below. The example shown in FIG. 2 may comprise one or more optional or additional features corresponding to one or more aspects mentioned in connection with the proposed concept or one or more examples described above (e.g., FIG. 1) and/or below (e.g., FIGS. 3-6).

FIG. 3 shows an example of a flow diagram of grayscale distance transformation 300. The grayscale distance transformation 300 may be performed by an apparatus as described above, e.g., with reference to FIG. 1.

The method 300 may comprise obtaining reference sample data, e.g., a reference marker image 210 (e.g., the first image). At 320 (T₁-Tₙ) a sequence of multiple thresholds, denoted as T₁<T₂<T₃< . . . <Tₙ, may be sequentially applied on the reference marker image 210. Applying the multiple thresholds T₁-Tₙ on the reference marker image 210 creates a set of binary masks 330₁, 330₂, 330₃, and so forth, up to the 330ₙ.

At 340 a distance transformation, e.g., a regular distance transformation, is applied on each of the binary masks 330₁, . . . , 330ₙ. Applying the distance transformation results in the generation of a set of distance transformed images 350₁, 350₂, 350₃, and so forth, up to the 350ₙ.

At 360 an averaging process may be performed on all the distance transformed images 350₁, . . . , 350ₙ. The averaging process generates a (averaged) grayscale distance transformed image 370. For example distance transformed image 370 may correspond to the distance transformed image depicted in FIG. 2 (reference sign 220).

More details and aspects are mentioned in connection with the examples described above and/or below. The example shown in FIG. 3 may comprise one or more optional or additional features corresponding to one or more aspects mentioned in connection with the proposed concept or one or more examples described above (e.g., FIGS. 1-2) and/or below (e.g., FIGS. 4-6).

FIGS. 4a-4i show examples of mapping functions. FIGS. 4a-4c show different monotonically decreasing functions 410, 420, 430 which could be used as mapping function. A monotonically decreasing function 410, 420, 430 will enhance the target signals that are close to the reference signals and suppress target signals that are distance from the reference signals. For example, a Cauchy distribution function 410 (FIG. 4a), a T-distribution function 420 (FIG. 4b, also referred to as Student's t-distribution function) or a flipped sigmoid function 430 (FIG. 4c) may be used.

FIGS. 4d-4g show different increasing functions 440, 450, 460, 470 which could be used as mapping function. A monotonically increasing function 440, 450, 460, 470 will suppress the target signals that are close to the reference signals and enhance target signals that are distance from the reference signals. For example, an exponential function 440 (FIG. 4d), a quadratic function 450 (FIG. 4e), a sigmoid function 460 (FIG. 4f) or a Cauchy loss function 470 (FIG. 4g) may be used.

FIGS. 4h and 4i show a band pass function 480 (FIG. 4h) and an inverse band pass function 490 (FIG. 4i) which could be used as mapping function. A band pass function 480 or an inverse band pass function 490 will enhance the target signals falling within a specific distance range from the reference signals, while suppress target signals that lie outside of this range.

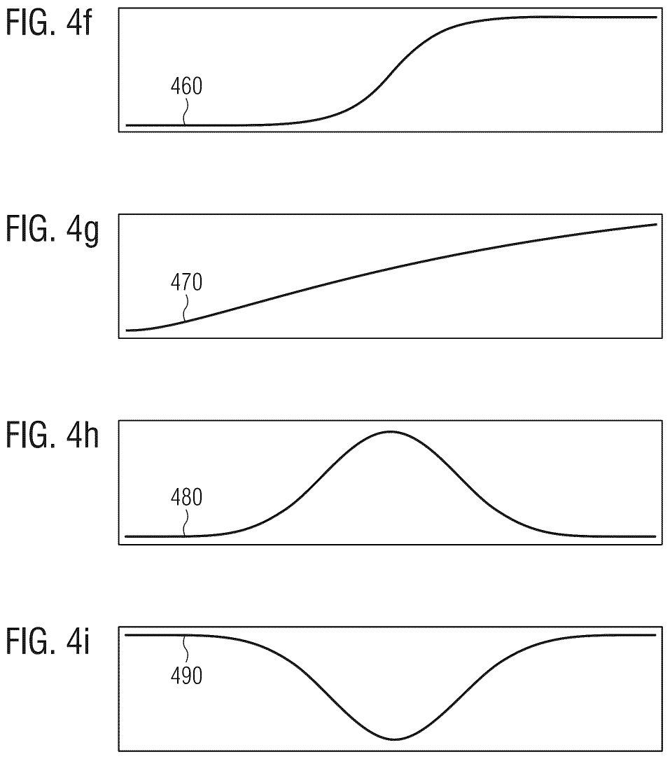

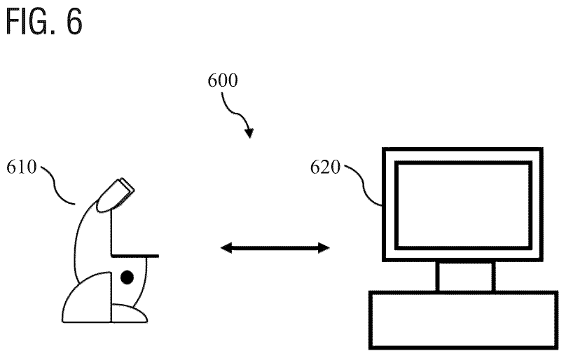

More details and aspects are mentioned in connection with the examples described above and/or below. The example shown in FIG. 4 may comprise one or more optional or additional features corresponding to one or more aspects mentioned in connection with the proposed concept or one or more examples described above (e.g., FIGS. 1-3) and/or below (e.g., FIG. 5-6).

FIG. 5 shows a flow diagram of a method 500. The method 500 comprises obtaining 510 reference sample data indicative of a first image of a sample from a first channel and obtaining 520 threshold data indicative of a plurality of thresholds for performing a distance transformation. Further, the method 500 comprises generating 530, using at least two thresholds of the plurality of thresholds, reference data by applying the distance transformation to the reference sample data and obtaining 540 sample data indicative of a second image of the sample from a second channel different from the first channel. The method 500 further comprises generating 550, based on the reference data and the sample data, structure image data indicative of a structure of the sample. The method 500 may be performed by an apparatus as described above, e.g., with reference to FIG. 1.

More details and aspects are mentioned in connection with the examples described above and/or below. The example shown in FIG. 5 may comprise one or more optional or additional features corresponding to one or more aspects mentioned in connection with the proposed concept or one or more examples described above (e.g., FIGS. 1-4) and/or below (e.g., FIG. 6).

Some embodiments relate to a microscope comprising an apparatus as described in connection with FIG. 1. Alternatively, a microscope or an optical imaging system can be communicatively connected to an apparatus as described in connection with FIG. 1. FIG. 6 shows a schematic illustration of a system 600, e.g., an optical imaging system, configured to perform a method described herein, e.g., with reference to one or more of FIG. 2 or 5. The system 600 comprises a microscope 610 and a computer system 620. The microscope may comprise the apparatus as described above, e.g., with reference to FIG. 1. The microscope 610 is configured to take images and is connected to the computer system 620.

The computer system 620 is configured to execute at least a part of a method described herein. The computer system 620 may be configured to execute a machine learning algorithm. The computer system 620 and microscope 610 may be separate entities but can also be integrated together in one common housing. The computer system 620 may be part of a central processing system of the microscope 610 and/or the computer system 620 may be part of a subcomponent of the microscope 610, such as a sensor, an actor, a camera or an illumination unit, etc. of the microscope 610.

The computer system 620 may be a local computer device (e.g., personal computer, laptop, tablet computer or mobile phone) with one or more processors and one or more storage devices or may be a distributed computer system (e.g., a cloud computing system with one or more processors and one or more storage devices distributed at various locations, for example, at a local client and/or one or more remote server farms and/or data centers). The computer system 620 may comprise any circuit or combination of circuits. In one embodiment, the computer system 620 may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), for example, of a microscope or a microscope component (e.g., camera) or any other type of processor or processing circuit. Other types of circuits that may be included in the computer system 620 may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system 620 may include one or more storage devices, which may include one or more memory elements suitable to the particular application, such as a main memory in the form of random access memory (RAM), one or more hard drives, and/or one or more drives that handle removable media such as compact disks (CD), flash memory cards, digital video disk (DVD), and the like. The computer system 620 may also include a display device, one or more speakers, and a keyboard and/or controller, which can include a mouse, trackball, touch screen, voice-recognition device, or any other device that permits a system user to input information into and receive information from the computer system 620.

More details and aspects are mentioned in connection with the examples described above. The example shown in FIG. 6 may comprise one or more optional or additional features corresponding to one or more aspects mentioned in connection with the proposed concept or one or more examples described above (e.g., FIGS. 1-5).

Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine readable carrier.

Other embodiments comprise the computer program for performing one of the methods described herein, stored on a machine readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor.

The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

If some aspects have been described in relation to a device or system, these aspects should also be understood as a description of the corresponding method and vice versa. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

The aspects and features described in relation to a particular one of the previous examples may also be combined with one or more of the further examples to replace an identical or similar feature of that further example or to additionally introduce the features into the further example.

### LIST OF REFERENCE SIGNS

130 apparatus
132 interface
134 processor
200 method for generating structure image data
210 reference marker image
220 applying a distance transformation
230 distance transformed image
240 applying a mapping function
250 mapped distance transformed image
260 target marker image
270 applying a superposition
280 spatial contextual feature image
300 method for grayscale distance transformation
320 (T₁-Tₙ) applying a sequence of multiple thresholds
T₁-Tₙ thresholds
330₁, . . . , 330ₙ binary masks
340 applying distance transformation
350₁, 350₂, 350₃ distance transformed images
360 performing an averaging process
370 distance transformed image
410 Cauchy distribution function
420 T-distribution function
430 flipped sigmoid function
440 exponential function
450 quadratic function
460 a sigmoid function
470 Cauchy loss function
480 band pass function
490 inverse band pass functions
500 method
510 obtaining reference sample data
520 obtaining threshold data
530 generating reference data
540 obtaining sample data
550 generating structure image data
600 system
610 microscope
620 computer system

1. An apparatus, comprising one or more processors and one or more storage devices, wherein the apparatus is configured to:
obtain reference sample data indicative of a first image of a sample from a first channel;
obtain threshold data indicative of a plurality of thresholds for performing a distance transformation;
generate, using at least two thresholds of the plurality of thresholds, reference data by applying the distance transformation to the reference sample data;
obtain sample data indicative of a second image of the sample from a second channel different from the first channel; and
generate, based on the reference data and the sample data, structure image data indicative of a structure of the sample.

2. The apparatus according to claim 1, wherein generating the reference data comprises applying a mapping function to a distance transformed first image of the sample.

3. The apparatus according to claim 1, wherein the mapping function is at least one of a monotonically decreasing function, a monotonically increasing function and a band pass function.

4. The apparatus according to claim 1, wherein the distance transformation is a grayscale distance transformation.

5. The apparatus according to claim 1, wherein the apparatus is configured to generate, based on the structure image data and the reference data, superposition image data indicative of the structure of the image.

6. The apparatus according to claim 1, wherein a threshold of the plurality of thresholds for performing the distance transformation is an intensity threshold for retaining or for excluding pixels for performing the distance transformation.

7. The apparatus according to claim 1, wherein the apparatus is configured to generate, based on the reference sample data and the threshold data, intermediate binary data indicative of a plurality of binary-like representations or a plurality of binary masks for performing the distance transformation and wherein generating the reference data comprises applying the distance transformation to the binary data for generating a plurality of distance transformed first images.

8. The apparatus according to claim 1, wherein the first channel and the second are part of one multiplexed image set.

9. The apparatus according to claim 1, wherein generate the structure image data is a segmentation-free process.

10. The apparatus according to claim 1, wherein generating the structure image data retains an unsegmented characteristic of the first image of the sample and the second image of the sample.

11. The apparatus according to claim 1, wherein generating the structure image data comprises emphasizing a part of the second image corresponding to a part of the reference data with a short distance and/or attenuating a part of the second image corresponding to a part of reference data with a long distance.

12. The apparatus according to claim 1, wherein generating the structure image data comprises emphasizing a spatial feature in the sample image data that corresponds to a structure represented by distance values in the reference data.

13. The apparatus according to claim 1, wherein the reference sample data is raw reference sample data of the first image of the sample and the distance transformation for generating the reference data is applied to the raw reference sample data.

14. The apparatus according to claim 13, wherein the sample data is raw sample data of the second image, and generating the structure image data comprises superposition of the reference data with the raw sample data.

15. The apparatus according to claim 1, wherein the first image of the sample is indicative of a first biomarker and the second image of the sample is indicative of a second biomarker.

16. An optical imaging system, comprising the apparatus of claim 1.

17. A method for an optical imaging system, comprising:
obtaining reference sample data indicative of a first image of a sample from a first channel;
obtaining threshold data indicative of a plurality of thresholds for performing a distance transformation;
generating, using at least two thresholds of the plurality of thresholds, reference data by applying the distance transformation to the reference sample data;
obtaining sample data indicative of a second image of the sample from a second channel different from the first channel; and
generating, based on the reference data and the sample data, structure image data indicative of a structure of the sample.

18. A non-transitory computer readable medium including code, when executed, to cause a machine to perform the method of claim 17.
